(19) United States
(12) Patent Application Publication
(10) Pub. No.: US 2024/0406830 A1
(43) Pub. Date: Dec. 5, 2024

(54) METHODS AND APPARATUSES FOR A MRO MECHANISM

(71) Applicant: LENOVO (BEIJING) LIMITED, Beijing (CN)

(72) Inventors: Le YAN, Shanghai (CN); Mingzeng DAI, Shanghai (CN); Lianhai WU, Beijing (CN); Congchi ZHANG, Shanghai (CN); Yibin ZHUO, Shanghai (CN)

(21) Appl. No.: 18/697,225

(22) PCT Filed: Sep. 30, 2021
(86) PCT No.: PCT/CN2021/122289

§ 371 Date: Mar. 29, 2024

(51) Int. Cl. H04W 36/30; H04W 36/00; H04W 36/36

(52) U.S. Cl. CPC H04W 36/305; H04W 36/0058; H04W 36/362

(57) ABSTRACT

Embodiments of the present application relate to methods and apparatuses for a mobility robustness optimisation (MRO) mechanism. According to an embodiment of the present application, a UE includes a processor and a wireless transceiver coupled to the processor; and the processor is configured: to store information including distance information associated with a distance between the UE and a reference location, wherein the information is at least one of radio link failure (RLF) related information, handover failure related information, or handover success related information; and to transmit the information via the wireless transceiver to a network node.

### TECHNICAL FIELD

Embodiments of the present application generally relate to wireless communication technology, in particular to methods and apparatuses for a mobility robustness optimisation (MRO) mechanism.

### BACKGROUND

A base station (BS) can have some cells (or areas) to provide communication service. When a user equipment (UE) moves from a serving cell of a source BS to a target cell of a target BS, a handover procedure is performed. When a radio link failure (RLF) or a handover (HO) failure occurs for a UE, the UE may perform a radio resource control (RRC) re-establishment procedure. Failure related information can be logged or stored by the UE in a RLF report. The UE may access a cell by a successful RRC re-establishment procedure. The accessed network will request UE information including a RLF report of the UE if it knows that the UE has logged or stored a RLF report, such that the network can optimize the mobility problem based on the UE information from the UE. Accordingly, the UE will transmit the failure related information via a RLF report to the network.

3rd Generation Partnership Project (3GPP) 5G networks are expected to increase network throughput, coverage, and robustness and reduce latency and power consumption. With the development of 3GPP 5G networks, various aspects need to be studied and developed to perfect the 5G technology. Details regarding a MRO mechanism for some scenarios during a handover procedure (e.g., a traditional handover procedure, a DAPS HO procedure, and/or a CHO procedure) have not been discussed in 3GPP 5G technology yet.

### SUMMARY

Some embodiments of the present application also provide a UE. The UE includes a processor and a wireless transceiver coupled to the processor; and the processor is configured: to store information including distance information associated with a distance between the UE and a reference location, wherein the information is at least one of radio link failure (RLF) related information, handover failure related information, or handover success related information; and to transmit the information via the wireless transceiver to a network node.

Some embodiments of the present application provide a method, which may be performed by a UE. The method includes: storing information including distance information associated with a distance between the UE and a reference location, wherein the information is at least one of RLF related information, handover failure related information, or handover success related information; and transmitting the stored information to a network node.

Some embodiments of the present application also provide an apparatus for wireless communications. The apparatus includes: a non-transitory computer-readable medium having stored thereon computer-executable instructions; a receiving circuitry; a transmitting circuitry; and a processor coupled to the non-transitory computer-readable medium, the receiving circuitry and the transmitting circuitry, wherein the computer-executable instructions cause the processor to implement any of the above-mentioned method performed by a UE.

Some embodiments of the present application also provide a network node (e.g., a BS). The network node includes a processor and a wireless transceiver coupled to the processor; and the processor is configured: to receive, via the wireless transceiver from a UE, an indicator indicating that information is stored in the UE, wherein the information is at least one of RLF related information, handover failure related information, or handover success related information, and wherein the information includes distance information associated with a distance between the UE and a reference location; to transmit, via the wireless transceiver to the UE, a request for the information; and to receive the information via the wireless transceiver from the UE.

Some embodiments of the present application provide a method, which may be performed by a network node (e.g., a BS). The method includes: receiving, from a UE, an indicator indicating that information is stored in the UE, wherein the information includes distance information associated with a distance between the UE and a reference location, and wherein the information is at least one of RLF related information, handover failure related information, or handover success related information; transmitting, to the UE, a request for the information; and receiving the information from the UE.

Some embodiments of the present application provide an apparatus. The apparatus includes: a non-transitory computer-readable medium having stored thereon computer-executable instructions, a receiving circuitry; a transmitting circuitry; and a processor coupled to the non-transitory computer-readable medium, the receiving circuitry and the transmitting circuitry, wherein the computer-executable instructions cause the processor to implement the abovementioned method performed by a network node (e.g., a BS).

The details of one or more examples are set forth in the accompanying drawings and the descriptions below. Other features, objects, and advantages will be apparent from the descriptions and drawings, and from the claims.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 illustrates a schematic diagram of a wireless communication system in accordance with some embodiments of the present application;

FIG. 2 illustrates an exemplary block diagram of an apparatus according to some embodiments of the present application;

FIG. 3 illustrates a flow chart of a method for storing distance information associated with a distance between a UE and a reference location according to some embodiments of the present application; and

FIG. 4 illustrates a flow chart of a method for receiving distance information associated with a distance between a UE and a reference location according to some embodiments of the present application.

### DETAILED DESCRIPTION

The detailed description of the appended drawings is intended as a description of preferred embodiments of the present application and is not intended to represent the only form in which the present application may be practiced. It should be understood that the same or equivalent functions may be accomplished by different embodiments that are intended to be encompassed within the spirit and scope of the present application.

Reference will now be made in detail to some embodiments of the present application, examples of which are illustrated in the accompanying drawings. To facilitate understanding, embodiments are provided under specific network architecture and new service scenarios, such as 3GPP LTE and LTE advanced, 3GPP 5G NR, 5G-Advanced, 6G, and so on. It is contemplated that along with developments of network architectures and new service scenarios, all embodiments in the present application are also applicable to similar technical problems; and moreover, the terminologies recited in the present application may change, which should not affect the principle of the present application.

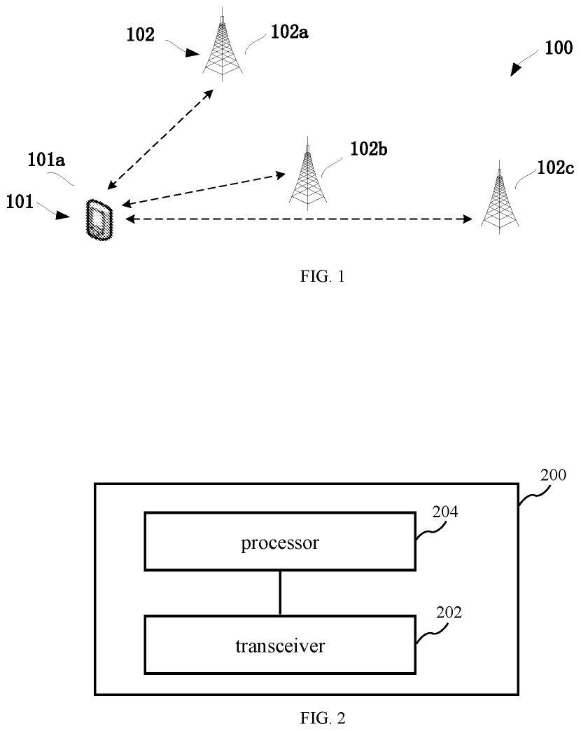

FIG. 1 illustrates a schematic diagram of a wireless communication system in accordance with some embodiments of the present application.

As shown and illustrated in FIG. 1, a wireless communication system 100 includes at least one UE 101 and at least one BS 102. In particular, the wireless communication system 100 includes one UE 101 (e.g., UE 101a) and three BSs 102 (e.g., BS 102a, BS 102b, and BS 102c) for illustrative purpose. Although a specific number of UEs 101 and BSs 102 are depicted in FIG. 1, it is contemplated that any number of UEs 101 and BSs 102 may be included in the wireless communication system 100.

UE(s) 101 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), internet of things (IoT) devices, or the like. According to some embodiments of the present application, UE(s) 101 may include a portable wireless communication device, a smart phone, a cellular telephone, a flip phone, a device having a subscriber identity module, a personal computer, a selective call receiver, or any other device that is capable of transmitting and receiving communication signals on a wireless network. In some embodiments of the present application, UE(s) 101 includes wearable devices, such as smart watches, fitness bands, optical head-mounted displays, or the like. Moreover, UE(s) 101 may be referred to as a subscriber unit, a mobile, a mobile station, a user, a terminal, a mobile terminal, a wireless terminal, a fixed terminal, a subscriber station, a user terminal, or a device, or described using other terminology used in the art. UE(s) 101 may communicate directly with BSs 102 via uplink (UL) communication signals.

In some embodiments of the present application, each of UE(s) 101 may be deployed an IoT application, an eMBB application and/or an URLLC application. It is contemplated that the specific type of application(s) deployed in UE(s) 101 may be varied and not limited.

BS(s) 102 may be distributed over a geographic region. In certain embodiments of the present application, each of BS(s) 102 may also be referred to as an access point, an access terminal, a base, a base unit, a macro cell, a Node-B, an evolved Node B (eNB), a gNB, a NG-RAN (Next Generation-Radio Access Network) node, a Home Node-B, a relay node, or a device, or described using other terminology used in the art. BS(s) 102 is generally a part of a radio access network that may include one or more controllers communicably coupled to one or more corresponding BS(s) 102.

The wireless communication system 100 may be compatible with any type of network that is capable of transmitting and receiving wireless communication signals. For example, the wireless communication system 100 is compatible with a wireless communication network, a cellular telephone network, a Time Division Multiple Access (TDMA)-based network, a Code Division Multiple Access (CDMA)-based network, an Orthogonal Frequency Division Multiple Access (OFDMA)-based network, an LTE network, a 3GPP-based network, a 3GPP 5G network, a satellite communications network, a high altitude platform network, and/or other communications networks.

In some embodiments of the present application, the wireless communication system 100 is compatible with the 5G of the 3GPP protocol, wherein BS(s) 102 transmit data using an OFDM modulation scheme on the downlink (DL) and UE(s) 101 transmit data on the UL using a single-carrier frequency division multiple access (SC-FDMA) or OFDM scheme. More generally, however, the wireless communication system 100 may implement some other open or proprietary communication protocols, for example, WiMAX, among other protocols.

In some embodiments of the present application, BS(s) 102 may communicate using other communication protocols, such as the IEEE 802.11 family of wireless communication protocols. Further, in some embodiments of the present application, BS(s) 102 may communicate over licensed spectrums, whereas in other embodiments, BS(s) 102 may communicate over unlicensed spectrums. The present application is not intended to be limited to the implementation of any particular wireless communication system architecture or protocol. In yet some embodiments of present application, BS(s) 102 may communicate with UE(s) 101 using the 3GPP 5G protocols.

Each BS(s) 102 may include one or more cells. Each UE(s) 101 may perform a cell section procedure between different cell(s) of different BS(s). Each UE(s) 101 may handover from a serving cell of a source BS to a target cell of a target BS. For example, in the wireless communication system 100 as shown and illustrated in FIG. 1, BS 102a may function as a source BS, and each of BS 102b and BS 102c may function as a target BS. If there is a handover need, UE 101a as shown and illustrated in FIG. 1 may perform a handover procedure from a serving cell of BS 102a to a target cell of BS 102b or a target cell of BS 102c, which depends on which cell is selected as a target cell. The handover procedure performed by UE 101a may be a CHO procedure.

As specified in 3GPP standard documents, a CHO procedure is defined as a handover that is executed by a UE when one or more handover execution conditions are met. A UE starts evaluating the execution condition(s) upon receiving the CHO configuration, and stops evaluating the execution condition(s) during the CHO procedure once the execution condition(s) is met. As specified in 3GPP Rel-16, a CHO procedure (which is mainly for terrestrial network mobility), an execution condition or triggering event is based on radio link quality or radio resource management (RRM) measurement, e.g., CondEvent A3 or CondEvent A5 can be configured as a CHO execution condition.

In a MRO mechanism for 3GPP Rel-16 CHO in a terrestrial network (TN), since a source node provides a radio link quality based CHO execution condition (e.g., CondEvent A3 or A5) to a UE, and it is the UE to decide when to execute a handover, the source node has no idea when the UE performs the CHO execution. The time elapsed since receiving the CHO configuration until the CHO execution is useful for the source node to decide whether CHO configuration is provided too early or too late to the UE. For example, if the CHO configuration is provided too early to the UE, it makes unnecessary radio resource reservation in the target BS. Therefore, it is useful for the UE to log and report the time elapsed from receiving CHO configurations to when the CHO procedure is executed. On the other hand, in a MRO mechanism for a traditional handover procedure, the handover reported timer (TimeConnFailure, which indicates the time elapsed since the last handover initialization until a connection failure) is very important for failure type detection in the MRO mechanism. For example, for a too early handover procedure, the time is less than the configured time (e.g., Tstore UE cntxt). Similarly, for a CHO procedure, it is useful for a UE to report the time elapsed since the CHO execution until a connection failure.

In 3GPP Rel-17, a location based CHO procedure and a time based CHO procedure are both introduced for a non-terrestrial network (NTN). A location based CHO procedure supports a CHO location trigger condition relating to a distance between a UE and a reference location. The reference location may be configured as a serving cell reference location or a candidate target cell reference location. A location based CHO procedure supports joint configuration of location and radio link quality based CHO execution condition(s) (e.g., CondEvent A3, A4, or A5). Moreover, a location based CHO procedure supports CondEvent L4, where “a distance between the UE and the PCell's reference location becomes greater than one absolute threshold” and “the distance between the UE and the conditional reconfiguration candidate or the candidate target cell becomes shorter than another absolute threshold”. A location based CHO procedure also supports CondEvent L3, where “a distance between UE and the PCell's reference location” becomes offset greater than “the distance between the UE and the conditional reconfiguration candidate or the candidate target cell”. In this specification, a candidate target cell is a CHO candidate cell.

Specifically, details for a CHO execution condition considering a location and radio link quality are as below:
Case A: a location based CHO execution condition together with a radio link quality based CHO execution condition (e.g., CondEvent A3, A4, or A5) are configured as CHO execution conditions. In this case, a target cell can be selected when both “corresponding location based CHO execution condition” and “radio link quality based CHO execution condition” are met, and then, a CHO execution procedure is performed with the selected target cell. For example, the CHO execution procedure is that a UE performs a random access channel (RACH) procedure towards the selected target cell.
   Case A-1: a network node configures a location based condition (e.g., CondEvent L4) and a RRM measurement based condition (e.g., CondEvent A3, A4, or A5) as CHO execution conditions.
   Case A-2: a network node configures a location based condition (e.g., CondEvent L3) and RRM measurement based condition (e.g., CondEvent A3, A4, or A5) as CHO execution conditions.

In a time based CHO procedure, a CHO time trigger event is defined as time duration [T1, T2] associated with each CHO candidate cell. A UE shall execute a CHO procedure to that candidate cell during the time duration, if all other configured CHO execution conditions will apply and there is only one triggered candidate cell. A time based CHO procedure supports UTC time+duration/timer, e.g., 00:00:01+40s for representing T1 and T2 for a CHO time event. A time based CHO procedure also supports joint configuration of time and radio link quality based CHO execution condition(s) (e.g., CondEvent A3, A4, or A5).

Specifically, details for CHO execution condition considering time and radio link quality are as below:
Case B: time based CHO execution condition together with radio link quality based CHO execution condition (e.g., CondEvent A3, A4, or A5) are configured as the CHO execution condition. In this case, a target cell can be selected when both corresponding time based CHO execution condition and radio link quality based CHO execution condition are met, then, the CHO execution procedure is performed with the selected target cell. For example, the CHO execution procedure is that a UE performs a random access channel (RACH) procedure towards the selected target cell.

In addition, in 3GPP Rel-17, a MRO mechanism could be enhanced to provide more robust mobility via introducing a successful handover report (SHR). In some embodiments of the present application, a successful handover report (SHR) may also mean “a HO Success Report” or the like. A UE could be configured with triggering condition(s) to compile the SHR. Hence, the SHR would be triggered only if the triggering condition(s) are met. Correspondingly, related information observed during the successful handover can be reported in the SHR. Then, the network node can optimize mobility parameter(s) to avoid a near failure successful handover. For example, for a traditional handover procedure, a network node can transmit a handover command (e.g., a RRCReconfiguration message carrying reconfigurationwithsync information element (IE)) a bit earlier or decrease a timer to trigger (TTT) a bit for a measurement report. For a CHO procedure, the network node can transmit the CHO handover command (e.g., a RRCReconfiguration message carrying CHO configurations) a bit earlier; or the network node can relax “the triggering reference signal received power (RSRP) threshold, the triggering reference signal received quality (RSRQ) threshold, or the triggering signal to interference plus noise ratio (SINR) threshold” a bit for CondEvent A3 or A5.

Currently, a UE may generate or log a SHR based on triggering condition(s), which includes at least one of:
(1) While doing a handover procedure, a running time length of timer T310 in a source cell of the UE exceeds a threshold.
(2) While doing a handover procedure, a running time length of timer T312 in the source cell of the UE exceeds a further threshold.
(3) While doing a handover procedure, a running time length of timer T304 in a target cell of the UE exceeds another threshold.

Currently, a SHR may include at least information of:
(1) Latest radio measurement result(s) of neighbor cell(s) in the case of a traditional handover procedure or of candidate target cell(s) in the case of a CHO procedure, before or when a handover procedure is executed, or when the handover procedure is successful.
(2) An indication to indicate which triggering condition(s) for generating or logging the SHR were fulfilled, e.g., a flag for indicating timers T310, T304, and/or T312.

Generally, as specified in 3GPP Rel-17, in a self-optimisation (SON) mechanism, cases need to be optimized include a RLF in a traditional handover procedure or a DAPS HO procedure or a CHO procedure, and/or a HO failure in the traditional handover procedure or the DAPS HO procedure or the CHO procedure. On the other hand, a MRO mechanism for a successful handover in the traditional handover procedure or the DAPS HO procedure or the CHO procedure needs to be optimized. For instance, following failure cases need to be addressed.
(1) Case 1: a CHO execution fails (a too early NTN CHO procedure or a CHO procedure to a wrong cell in NTN), or a handover failure occurs during a CHO execution procedure, e.g., the UE fails to handover to the target cell that selected from the CHO candidate cells, or a RLF occurs shortly in the target cell (that is selected from the CHO candidate cells) after a successful handover from the source cell to the target cell. In Case 1, issue 1 needed to be solved is: what assistant information should be reported to let a network node know that a distance based CHO triggering threshold is not proper.
(2) Case 2: a source RLF occurs before a CHO execution is triggered (a too late NTN CHO procedure), e.g., a RLF occurs in the source cell before a target cell is selected. In Case 2, issue 2 needed to be solved is: what assistant information should be reported to let a network node know that a distance based CHO triggering threshold needs to be relaxed.
(3) Case 3: a handover procedure for recovery fails after a failed CHO execution or a source RLF occurs. In Case 3, issue 3 needed to be solved is: what assistant information should be reported to a network node to enable a successful CHO procedure.
(4) Case 4: a handover procedure fails, e.g., the UE fails to handover to the target cell (that is included in the traditional handover command) or a RLF occurs shortly in the target cell (that is included in the traditional handover command) after a successful handover from the source cell to the target cell, or a source RLF occurs before a traditional handover command or a DAPS HO command is received, in a traditional handover procedure or a dual active protocol stack (DAPS) handover procedure. In Case 4, issue 4 needed to be solved is: what assistant information should be reported to a network node to optimize the mobility parameters.
(5) Case 5: a case of a SHR. In Case 5, issue 5 needed to be solved is: what is a new trigger condition for a SHR in a NTN mobility procedure including a traditional handover procedure or a DAPS HO procedure or a CHO procedure.

Embodiments of the present application aim to solve the above issues 1-5. Embodiments of the present application provide exemplary solutions of a MRO mechanism for a NTN scenario. It is contemplated that the solutions of a MRO mechanism provided in the embodiments of the present application are also applicable for any other possible scenario(s) that uses the location based CHO procedure and/or the time based CHO procedure. For example, the solutions of a MRO mechanism provided in the embodiments of the present application are also applicable for an unmanned aerial vehicle (UAV) scenario, a vehicle to everything (V2X) scenario and et al., which are not only limited to the exemplary NTN scenario.

In some embodiments of the present application for issues 1-4, “distance information which is derived based on satellite ephemeris and a UE's location when a RLF or a handover failure occurs” can be reported to a network node, as well as “an indication about whether a distance based CHO execution condition is met when a source RLF or a handover failure occurs”, to assist the network node to adjust the distance based CHO execution condition. The “handover” in these embodiments can be a traditional handover procedure, a DAPS handover procedure, a CHO procedure, or a handover to a selected candidate cell after a source RLF occurs or after a failed CHO execution procedure. A failed CHO execution procedure may be the case that the UE fails to handover to the target cell that is selected from the CHO candidate cells, or a RLF occurs shortly in the target cell (that is selected from the CHO candidate cells) after a successful handover from the source cell to the target cell.

In some embodiments of the present application for issue 5, new trigger conditions are introduced to report a SHR in a handover procedure including a traditional handover procedure or a DAPS HO procedure or a CHO procedure. For example, new trigger conditions may be: the elapsed time of the evaluation duration is greater than one threshold when performing the CHO procedure; the distance between a UE and a cell center of a serving cell is shorter than a threshold when performing the CHO procedure; or the distance between the UE and a cell center of a target cell is greater than a threshold when performing the CHO procedure. More details will be illustrated in the following text in combination with the appended drawings.

FIG. 2 illustrates an exemplary block diagram of an apparatus according to some embodiments of the present application. As shown in FIG. 2, the apparatus 200 may include at least one processor 204 and at least one transceiver 202 coupled to the processor 204. The apparatus 200 may be a UE or a network node (e.g., a BS).

Although in this figure, elements such as the at least one transceiver 202 and the processor 204 are described in the singular, the plural is contemplated unless a limitation to the singular is explicitly stated. In some embodiments of the present application, the transceiver 202 may be divided into two devices, such as a receiving circuitry and a transmitting circuitry. In some embodiments of the present application, the apparatus 200 may further include an input device, a memory, and/or other components.

In some embodiments of the present application, the apparatus 200 may be a UE (e.g., UE 101a or UE 101b as shown and illustrated in FIG. 1). For instance, the UE is a Tx UE (e.g., UE 101a as shown and illustrated in FIG. 1).

The processor 204 of the UE may be configured to store information which includes distance information associated with a distance between the UE and a reference location. The stored information may be RLF related information, and/or handover failure related information, and/or handover success related information. In some embodiments, the reference location is a cell center. In some embodiments, the reference location is a fixed location inside or outside of the cell, which may be configured to the UE by the network, at least including one of the longitude, latitude, and height. The processor 204 of the UE may be configured to transmit the stored information via the transceiver 202 of the UE to a network node (e.g., BS 102 as shown and illustrated in FIG. 1).

According to some embodiments, in response to an occurrence of at least one of “a RLF of a serving cell of the UE” or “a handover failure”, the distance information associated with the distance between the UE and the reference location is derived based on a satellite ephemeris and a location of the UE when at least one of the RLF or the handover failure occurs. The handover failure may be the case that the UE fails to access to the cell for handover, or a RLF occurs shortly in the cell for handover after a successful access to the cell. In other words, the handover failure may be the case that the UE fails to handover to the target cell, or a RLF occurs shortly in the target cell after a successful handover from the source cell to the target cell.

According to some embodiments, the distance information associated with the distance between the UE and the reference location includes at least one of:
(1) 1st distance: a distance between the UE and the reference location in a source cell of the UE;
(2) 2nd distance: a distance between the UE and the reference location in a target cell of the UE;
(3) 3rd distance: a distance between the UE and the reference location in a neighbor cell of the UE;
(4) 4th distance: a distance between the UE and the reference location in a CHO candidate cell of the UE;
(5) 1st distance difference: a distance difference between the 1st distance and the 2nd distance;
(6) 2nd distance difference: a distance difference between the 1st distance and the 3rd distance; or
(7) 3rd distance difference: a distance difference between the 1st distance and the 4th distance.

In some embodiments, if a handover procedure of the UE is successfully completed, the distance information includes at least one of:
(1) the 1st distance when the handover procedure is successful;
(2) the 2nd distance when the handover procedure is successful;
(3) the 1st distance difference when the handover procedure is successful;
(4) the 3rd distance difference when the handover procedure is successful;
(5) The 3rd distance when the handover procedure is successful;
(6) The 4th distance when the handover procedure is successful; or
(7) The 2nd distance difference when the handover procedure is successful.

According to some embodiments, if a handover procedure of the UE is successfully completed, the information stored in the UE is the handover success related information. The handover success related information may be transmitted in a successful handover report (SHR). In some embodiments, the handover success related information includes at least one of:
(1) an indication indicating which triggering condition for generating the SHR is fulfilled;
(2) time duration between “the UE receiving CHO configuration information” and “the UE selecting a target cell”;
(3) time duration between “the UE receiving a handover command” and “the UE selecting the target cell”; or
(4) time duration between “the UE starting to evaluate a CHO execution condition” and “the UE selecting the target cell”.

In some embodiments, the processor 204 of the UE may be configured to trigger to generate the SHR in response to meeting triggering condition(s). For example, the triggering condition(s) is one of:
(1) The 1st distance is shorter than a threshold while the UE is performing the handover procedure;
(2) The 2nd distance is greater than a further threshold while the UE is performing the handover procedure;
(3) The 1st distance difference is shorter than another threshold while the UE is performing the handover procedure;
(4) time duration between “the UE receiving CHO configuration information” and “the UE selecting the target cell” is greater than an additional threshold;
(5) time duration between “the UE receiving a handover command” and “the UE selecting the target cell” is greater than yet an additional threshold; or
(6) time duration between “the UE starting to evaluate a CHO execution condition” and “the UE selecting the target cell” is greater than yet another threshold.

In some embodiments, the processor 204 of the UE may be configured: to store status information of a distance based CHO execution condition, if a RLF of a serving cell of the UE or a handover failure occurs; and to transmit the status information via the transceiver 202 of the UE to a network node.

In some embodiments, the status information includes one of:
(1) a 1st indication, which indicates whether the distance based CHO execution condition is met when the RLF occurs;
(2) a 2nd indication, which indicates whether the distance based CHO execution condition is met when the handover failure occurs;
(3) a 3rd indication, which indicates whether “the distance between the UE and the reference location of a source cell” satisfies the distance based CHO execution condition when the RLF occurs;
(4) a 4th indication, which indicates whether “the distance between the UE and the reference location of a source cell” satisfies the distance based CHO execution condition when the handover failure occurs;
(5) a 5th indication, which indicates whether “the distance between the UE and the reference location of the target cell or a CHO candidate cell” satisfies the distance based CHO execution condition when the RLF occurs; or
(6) a 6th indication, which indicates whether “the distance between the UE and the reference location of the target cell or a CHO candidate cell” satisfies the distance based CHO execution condition when the handover failure occurs.

In some embodiments, if a handover failure occurs, the information stored in the UE may be handover failure related information. For instance, the handover failure may occur during one of following procedures:
(1) a traditional handover procedure;
(2) a DAPS handover procedure;
(3) a CHO execution procedure;
(4) a handover procedure to a selected CHO candidate cell after occurring a RLF of a source cell of the UE; or
(5) a handover procedure to a selected CHO candidate cell after a failed CHO execution procedure.

In some embodiments, the processor 204 of the UE may be configured: to transmit, via the transceiver 202 of the UE to a network node (e.g., BS 102 as shown and illustrated in FIG. 1), an indicator indicating that the information is stored in the UE; and to receive, via the transceiver 202 of the UE from the network node, a request for the stored information. The information stored in the UE is transmitted after the UE receiving the request.

In some embodiments of the present application, the apparatus 200 may be a network node (e.g., a BS, which may be BS 102 as shown and illustrated in FIG. 1). The processor 204 of the network node may be configured to receive, via the transceiver 202 of the network node from a UE (e.g., UE 101a as shown and illustrated in FIG. 1), an indicator indicating that information, which includes distance information associated with a distance between the UE and a reference location, is stored in the UE. The information stored in the UE is at least one of RLF related information, handover failure related information, or handover success related information. In some embodiments, the reference location is a cell center. The processor 204 of the network node may be configured to transmit a request for the stored information to the UE via the transceiver 202 of the network node. The processor 204 of the network node may be configured to receive, from the UE via the transceiver 202 of the network node, the information stored in the UE.

In some embodiments, the processor 204 of the network node may be further configured to modify mobility configuration information for the UE after receiving the information stored in the UE. In some embodiments, the mobility configuration information includes at least one of:
(1) a distance based traditional handover triggering threshold;
(2) a distance based DAPS handover triggering threshold;
(3) a distance based CHO execution condition; or
(4) a RRM based CHO execution condition.

In some embodiments, the processor 204 of the network node may be further configured to receive the SHR in response to meeting triggering condition(s). For example, the triggering condition(s) may be one of:
(1) The 1st distance is shorter than a threshold while the UE is performing the handover procedure;
(2) The 2nd distance is greater than a further threshold while the UE is performing the handover procedure;
(3) The 1st distance difference is shorter than another threshold while the UE is performing the handover procedure;
(4) time duration between “the UE receiving CHO configuration information” and “the UE selecting the target cell” is greater than an additional threshold;
(5) time duration between “the UE receiving a handover command” and “the UE selecting the target cell” is greater than yet another threshold; or
(6) time duration between “the UE starting to evaluate a CHO execution condition” and “the UE selecting the target cell” is greater than yet another threshold.

In some embodiments, the processor 204 of the network node may be further configured to modify mobility configuration information for the UE after receiving the SHR. For example, the mobility configuration information may include at least one of:
(1) a distance based traditional handover triggering threshold;
(2) a distance based DAPS handover triggering threshold;
(3) a distance based CHO execution condition;
(4) a time based traditional handover triggering threshold;
(5) a time based DAPS handover triggering threshold;
(6) a time based CHO execution condition; or
(7) a RRM based CHO execution condition.

In some embodiments, the processor 204 of the network node may be further configured to receive, via the transceiver 202 of the network node from the UE, status information of a distance based CHO execution condition, in response to an occurrence of a RLF of a serving cell of the UE or a handover failure.

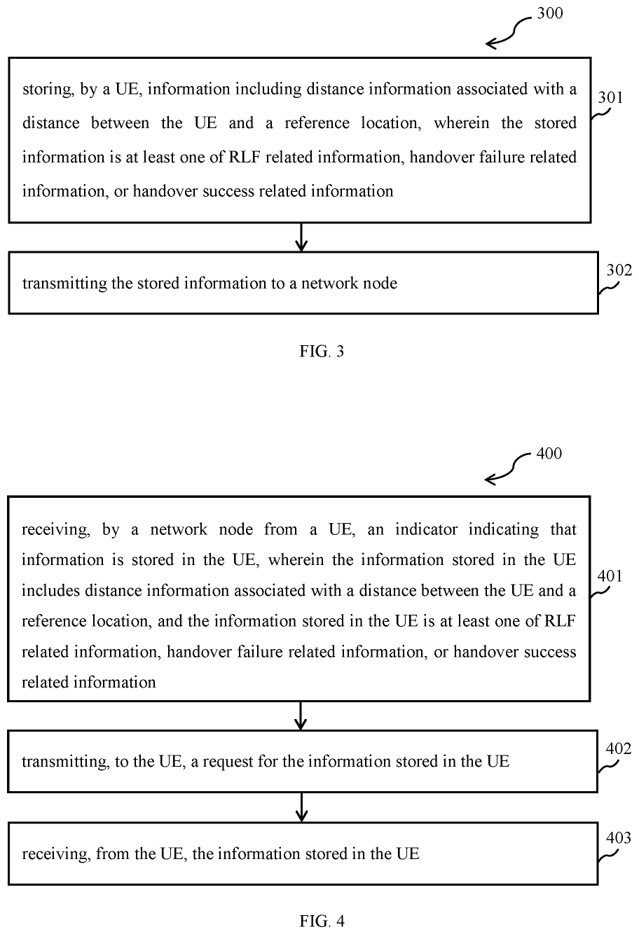

In some embodiments of the present application, the apparatus 200 may further include at least one non-transitory computer-readable medium. In some embodiments of the present disclosure, the non-transitory computer-readable medium may have stored thereon computer-executable instructions to cause a processor to implement the method with respect to a UE or a network node (e.g., a BS) as described above. For example, the computer-executable instructions, when executed, cause the processor 204 interacting with the transceiver 202, so as to perform operations of the methods, e.g., as described in view of FIGS. 3 and 4.

FIG. 3 illustrates a flow chart of a method for storing distance information associated with a distance between a UE and a reference location according to some embodiments of the present application. The method 300 may be performed by a UE (e.g., UE 101 as shown and illustrated in any of FIG. 1). Although described with respect to a UE, it should be understood that other devices may also be configured to perform the method as shown and illustrated in FIG. 3.

In the exemplary method 300 as shown in FIG. 3, in operation 301, a UE (e.g., UE 101 as shown and illustrated in FIG. 1) stores information including distance information associated with a distance between the UE and a reference location. The stored information is at least one of RLF related information, handover failure related information, or handover success related information. In operation 302, the UE transmits the stored information to a network node.

It is contemplated that the method illustrated in FIG. 3 may include other operation(s) not shown, for example, any operation(s) described with respect to FIGS. 2 and 4.

Details described in all other embodiments of the present application (for example, details regarding a MRO mechanism) are applicable for the embodiments of FIG. 3. Moreover, details described in the embodiments of FIG. 3 are applicable for all embodiments of FIGS. 1, 2 and 4.

FIG. 4 illustrates a flow chart of a method for receiving distance information associated with a distance between a UE and a reference location according to some embodiments of the present application. The embodiments of FIG. 4 may be performed by a network node (e.g., a BS, which may be BS 102 as shown and illustrated in FIG. 1). Although described with respect to a network node, it should be understood that other devices may be configured to perform a method similar to that of FIG. 4.

In the exemplary method 400 as shown in FIG. 4, in operation 401, a network node (e.g., BS 102 as shown and illustrated in FIG. 1) receives, from a UE (e.g., UE 101a as shown and illustrated in FIG. 1), an indicator which indicates that information is stored in the UE. The information stored in the UE includes distance information associated with a distance between the UE and a reference location. The information stored in the UE is RLF related information, and/or handover failure related information, and/or handover success related information.

In operation 402, the network node transmits, to the UE, a request for the information stored in the UE. In operation 403, the network node receives, from the UE, the information stored in the UE.

It is contemplated that the method illustrated in FIG. 4 may include other operation(s) not shown, for example, any operation(s) described with respect to FIGS. 2 and 3.

Details described in all other embodiments of the present application (for example, details regarding a MRO mechanism) are applicable for the embodiments of FIG. 4. Moreover, details described in the embodiments of FIG. 4 are applicable for all embodiments of FIGS. 1-3.

The following texts describe specific Embodiments 1-5 of the methods as shown and illustrated in FIGS. 2-4. According to Embodiments 1-5, a UE may be UE 101 as shown and illustrated in FIG. 1, and a network node may be BS 102a, BS 102b, or BS 102c as shown and illustrated in FIG. 1.

### Embodiment 1 (for Solving Issue 1)

In one example of Embodiment 1, it is assumed that the configured CHO execution condition for candidate cell 1 is {CondEvent L3 (e.g., a distance based triggering threshold is 40 km), CondEvent A4 (e.g., a RRM measurement based triggering threshold is 30 dB)}. For example, when the quality of candidate cell 1 is higher than 30 dB and when a distance difference between “a UE and a center of a serving cell (i.e., source cell)” and “the UE and a center of a candidate cell 1 (i.e., target cell)” is equal or greater than 40 km, CHO can be executed. That is, a CHO execution procedure is performed, i.e., the UE selects the candidate cell 1 as the target cell for handover. There is a case that the CHO execution fails and the UE re-establishes to the source cell, and thus it is beneficial to make the source node know that the CHO procedure is too early to be executed.

Based on the current MRO mechanism, the network node would increase the RRM measurement based triggering threshold (i.e., “30 dB”) based on the RLF report. However, the network node does not know whether a location based condition is proper or how to modify a location based condition if it is improper.

In this example of Embodiment 1, an actual case may be that the location based CHO execution condition is set too relaxed and a RRM measurement based CHO execution condition may be fine or a bit relaxed. For instance, when the CHO procedure is executed, a distance difference between “the UE and the center of the serving cell” and “the UE and the center of the candidate cell1” is 41 km, and the quality of candidate cell 1 is 30.01 dB. When a handover procedure to the candidate cell 1 fails, the distance difference between “the UE and the center of serving cell” and “the UE and the center of candidate cell1” is 43 km, and the quality of candidate cell 1 is 30.02 dB. When the UE re-establishes to the source cell, the distance difference between “the UE and the center of the serving cell” and “the UE and the center of the candidate cell1” is 45 km, and the quality of candidate cell 1 is 30.03 dB. Thus, it is beneficial to let the source node know that the distance based triggering threshold, i.e., “40 km”, is set too relaxed, and the RRM measurement based triggering threshold, i.e., “30 dB”, may be fine or a bit relaxed.

In this example of Embodiment 1, the UE can report: (1) the distance difference between “the UE and the center of the serving cell” and “the UE and the center of the candidate cell1” when the CHO is executed (i.e., “41 km”); (2) the distance difference between “the UE and the center of the serving cell” and “the UE and the center of the candidate cell1” when the CHO execution procedure fails (i.e., “43 km”); (3) the distance difference between “the UE and the center of the serving cell” and “the UE and the center of the candidate cell 1” when the UE re-establishes to the source cell (i.e., “45 km”); (4) an indication which indicates that the distance based CHO execution condition(s) for the target cell is met when the CHO execution procedure fails; and/or (5) an indication which indicates that the distance based CHO execution condition(s) for the target cell is met when the UE re-establishes to the source cell.

Thus, the network node may modify the location based CHO execution condition based on the reported information, i.e., to increase the distance based triggering threshold (e.g., to be greater than “45 km”), and keep or modify the RRM measurement based triggering threshold a bit.

In addition, in this example of Embodiment 1, the UE can also report: (1) the actual distance between the UE and the cell center of the serving cell; (2) the actual distance between the UE and the cell center of the target cell; (3) the actual distance between the UE and the cell center of the non-target CHO candidate cell; (4) the actual distance between the UE and the cell center of neighbor cell; at least when the CHO configurations are received, when the CHO is executed, when the CHO execution fails, when the UE performs a re-establishment procedure.

In general, in Embodiment 1, to enable a network node to decide whether CHO execution condition(s) are configured properly, some information needs to be reported by the UE. Then, the network node can modify the configurations including location based CHO execution condition(s), and/or radio link quality based CHO execution condition(s) if not proper.

In Embodiment 1, the UE can at least log and/or report:
(1) Distance related information when a handover procedure (i.e., CHO execution) fails, e.g., the distance related information can be the distance between the UE and the reference location (e.g., cell center) of the source cell or the serving cell, a distance between the UE and the reference location (e.g., cell center) of the target cell, a distance between the UE and the reference location (e.g., cell center) of a non-target CHO candidate cell, a distance between the UE and the reference location (e.g., cell center) of a neighbor (non-CHO candidate cell) cell, the distance difference between “the UE and the reference location (e.g., cell center) of the serving cell” and “the UE and the reference location (e.g., cell center) of the target cell”, the distance difference between “the UE and the reference location (e.g., cell center) of the source cell or the serving cell” and “the UE and the reference location (e.g., cell center) of the non-target CHO candidate cell”, the distance difference between “the UE and the reference location (e.g., cell center) of the serving cell” and “the UE and the reference location (e.g., cell center) of the neighbor (non-CHO candidate cell) cell”. The distance related information can be calculated based on the satellite ephemeris and the UE's location.
(2) An indication which indicates whether radio link quality based CHO execution condition(s) for the target cell is met, and/or an indication which indicates whether the distance based CHO execution condition for the target cell is met, at least when the CHO execution fails or when the UE performs RRC re-establishment procedure (the re-establishment cell may a source cell or another cell). The indication(s) can be used by the network node to decide whether location or radio link quality based CHO execution condition is proper. For example, if location and radio link quality based CHO execution conditions are met when the CHO execution procedure fails, the network node knows that the location and radio link quality based CHO execution conditions are set too relaxed, i.e., they needs to be modified strictly.
   a) Furthermore, in some sub-embodiments, if CondEvent L4 is configured as a location based CHO execution condition, since both “the distance between the UE and the reference location of a serving cell or a PCell” and “the distance between the UE and the reference location of a CHO candidate cell” are considered, it is beneficial for the network node to know whether “the distance between the UE and the serving cell's or the PCell's reference location” satisfies its related triggering condition, and whether “the distance between the UE and the CHO candidate cell's reference location” satisfies its related triggering condition, at least when the CHO execution fails or when the UE performs a RRC re-establishment procedure (the re-establishment cell may a source cell or another cell). Thus, it can know whether or how to modify CondEvent L4, e.g., whether to modify the distance based triggering threshold that is associated with the distance between the UE and the serving cell's or the PCell's reference location, or whether to modify the distance based triggering threshold that is associated with the distance between the UE and the CHO candidate cell's reference location, or both. So, the UE can log and/or report an indication about whether “the distance between the UE and the serving cell's or the PCell's reference location” satisfies its related triggering condition, and an indication about whether “the distance between the UE and the CHO candidate cell's reference location” satisfies its related triggering condition, at least when the CHO execution fails or when the UE performs the RRC re-establishment procedure.
(3) Distance related information when a handover procedure (i.e., CHO execution) is executed, e.g., when the target cell is selected from the CHO candidate cells. The distance can be calculated based on the satellite ephemeris and UE location. The distance related information can be the distance between the UE and the reference location (e.g., cell center) of the serving cell, a distance between the UE and the reference location (e.g., cell center) of the target cell, a distance between the UE and the reference location (e.g., cell center) of a non-target CHO candidate cell, the distance difference between “the UE and the reference location (e.g., cell center) the serving cell” and “the UE and the reference location (e.g., cell center) the target cell”, the distance difference between “the UE and the reference location (e.g., cell center) of the serving cell” and “the UE and the reference location (e.g., cell center) of the non-target CHO candidate cell”.
   a) In some sub-embodiments, if CondEvent L4 is configured as location based CHO execution condition, it is beneficial for the network node to know whether “the distance between the UE and the serving cell's or the PCell's reference location” satisfies its related triggering condition when the radio link quality based CHO execution condition is triggered, and whether “the distance between the UE and the CHO candidate cell's reference location” satisfies its related triggering condition when the radio link quality based CHO execution condition is triggered. Thus, the UE can log and/or report an indication about whether “the distance between the UE and the serving cell's or the PCell's reference location” satisfies its related triggering condition when the radio link quality based CHO execution condition is triggered, an indication about whether “the distance between the UE and the CHO candidate cell's reference location” satisfies its related triggering condition when the radio link quality based CHO execution condition is triggered, an indication about whether the radio link quality based CHO execution condition is triggered when “the distance between the UE and the serving cell's or the PCell's reference location” satisfies its related triggering condition, an indication about whether the radio link quality based CHO execution condition is triggered when “the distance between the UE and the CHO candidate cell's reference location” satisfies its related triggering condition
(4) Triggering order for a location based CHO execution condition and radio link quality based CHO execution condition; or, an indication about whether radio link quality based CHO execution condition is met or triggered when a distance based CHO execution condition is met or triggered, or an indication about whether a distance based CHO execution condition is met or triggered when the radio link quality based CHO execution condition is met or triggered.
(5) Distance related information when a radio link quality based CHO execution condition is met or triggered. The distance can be calculated based on the satellite ephemeris and the UE's location. The distance related information can refer to the above (1).
(6) RRM measurement results for source cell(s), target cell(s) and other CHO candidate cell(s) when a location based CHO execution condition is met or triggered.
(7) Distance related information when the CHO configuration(s) is received. The distance can be calculated based on the satellite ephemeris and the UE's location. The distance related information can refer to the above (1).
(8) Configured location based CHO execution condition.

In Embodiment 1, the UE indicates to the network node that it has logged and/or stored the above information, then the network request the UE to report the logged and/or stored information, the UE sends the logged and/or stored information to the network, e.g., the UE sends UEinformationresponse message to transfer a RLF report that including the logged and/or stored information. Based on the reported information from the UE, the network node can restrict or change the location based triggering condition and/or the radio link quality based triggering condition to avoid a too early handover procedure or a handover procedure to a wrong cell in NTN.

### Embodiment 2 (for Solving Issue 2)

In one example of Embodiment 2, it is assumed that the configured CHO execution condition for candidate cell 1 is {CondEvent L4 (e.g., a distance based triggering threshold is 20 km and 10 km), CondEvent A4 (e.g., RRM measurement based triggering threshold is 5 dB)}. For example, when the quality of candidate cell 1 is at least 5 dB higher than the serving cell (i.e., source cell), and a distance between the UE and the source cell's reference location (e.g., a cell center) becomes greater than 20 km and the distance between the UE and the candidate cell 1's reference location becomes shorter than 10 km, CHO can be executed. That is, CHO execution is performed, i.e., the UE selects the candidate cell 1 as the target cell for handover.

There is a case that a source RLF occurs before CHO execution, it is beneficial to make the source node know that the CHO procedure is too late to be executed. Based on the current MRO mechanism, the network node would decrease the RRM measurement based triggering offset (i.e., “5 dB”) based on the RLF report. However, the network node does not know whether a location based condition is proper or how to modify the location based condition if it is improper.

In this example of Embodiment 2, an actual case may be that the radio link quality based CHO execution condition is met but location based CHO execution condition is not met before or when a source RLF happens, i.e., a RLF occurs in the source cell. For instance, when a source RLF occurs, the quality of candidate cell 1 is 7 dB higher than the serving cell, the distance between the UE and the source cell's reference location is 18 km and the distance between the UE and the candidate cell 1's reference location is 12 km). Thus, it is beneficial to let the source node know that the distance based triggering threshold, i.e., “20 km” and “10 km”, are not proper, but “5 dB” is fine.

In this example of Embodiment 2, there is one case that the distance between the UE and the source cell's reference location does not satisfy its related triggering condition, and the distance between the UE and the CHO candidate cell's reference location does not satisfy its related triggering condition. Besides this case, there are other two cases:
(1) The distance between the UE and the source cell's reference location satisfies its related triggering condition, and the distance between the UE and the CHO candidate cell's reference location does not satisfy its related triggering condition. For instance, a distance between the UE and the source cell's reference location is 21 km, and the distance between the UE and the candidate cell 1's reference location is 12 km.
(2) The distance between the UE and the source cell's reference location does not satisfy its related triggering condition, and the distance between the UE and the CHO candidate cell's reference location satisfies its related triggering condition. For instance, a distance between the UE and the source cell's reference location is 18 km and the distance between the UE and the candidate cell 1's reference location is 8 km.

For instance, the UE can log and/or report: (1) the distance between the UE and the source cell's reference location when a source RLF occurs (i.e., 18 km); (2) the distance between the UE and the candidate cell 1's reference location when the source RLF occurs (i.e., 12 km); (3) indication(s) which indicates that a radio link quality based CHO execution condition is met but a distance based CHO execution condition is not met when the source RLF occurs; (4) an indication which indicates that the distance between the UE and the source cell's reference location does not satisfy its related triggering condition when the source RLF occurs; and/or (5) an indication which indicates that the distance between the UE and the candidate cell 1's reference location does not satisfy its related triggering condition when the source RLF occurs.

Based on the information reported by the UE, the network node can only modify the location based CHO execution condition, i.e., to relax a triggering distance threshold, but keep the radio link quality based CHO execution condition. For example, for relaxing a triggering distance threshold, the triggering threshold related with the distance between the UE and the cell center of the serving cell can be modified to be a bit lower than the actual distance between the UE and the cell center of the serving cell when the source RLF occurs. The triggering threshold related with the distance between the UE and the cell center of the candidate cell1 can be modified to be a bit higher than the actual distance between the UE and the cell center of the candidate cell1 when the source RLF occurs. For example, the distance based triggering threshold can be modified to be 17 km and 13 km.

In general, in Embodiment 2, to enable a network node to know that a CHO procedure is too late to be executed, and let the network node to modify configurations including a location based CHO execution condition or a radio link quality based CHO execution condition to avoid such scenario, the UE can at least log and/or report at least one of:
(1) Distance related information when a source RLF occurs, e.g., upon timer T310 or T312 expires (before CHO execution procedure). For instance, the distance related information can be: 1) a distance between a UE and reference location (e.g., cell center) of a source cell or a serving cell; 2) a distance between the UE and reference location (e.g., cell center) of a CHO candidate cell; and 3) a distance difference between “the UE and reference location (e.g., cell center) of the source cell or the serving cell” and “the UE and the reference location (e.g., cell center) of the CHO candidate cell”. The distance can be calculated based on the satellite ephemeris and the UE's location. The distance related information can be used by the network node to decide how to modify the location based CHO execution condition.
(2) An indication which indicates whether a distance based CHO execution condition is met when a RLF occurs in the source cell, and/or an indication which indicates whether a radio link quality based CHO execution condition is met when the RLF occurs in the source cell. The indication(s) can be used by the network node to decide whether the location based CHO execution condition and/or the radio link quality based CHO execution condition is proper. For example, if a distance based CHO execution condition is not met but a radio link quality based CHO execution condition is met when a RLF occurs in the source cell, the network node can modify the location based CHO execution condition.
(3) An indication which indicates whether “the distance between the UE and the reference location (e.g., cell center) of a source PCell, a source cell, or a serving cell” satisfies its related triggering condition (e.g., the triggering threshold related with distance between UE and the reference location (e.g., cell center) of the source cell) when a source RLF occurs; and/or an indication which indicates whether” the distance between the UE and the CHO candidate cell's reference location (e.g., cell center)” satisfies its related triggering condition (e.g., the triggering threshold related with distance between the UE and the reference location (e.g., cell center) of the CHO candidate cell) when the source RLF occurs. Together with the indication in above bullet (2), these indications can be used by the network node to decide whether the triggering threshold related with the distance between the UE and the reference location (e.g., cell center) of the source cell and/or the triggering threshold related with the distance between the UE and the reference location (e.g., cell center) of the CHO candidate cell is proper.
   a) For example, if a radio link quality based CHO execution condition is met when a source RLF occurs, if the triggering threshold related with distance between the UE and the reference location (e.g., cell center) of the source cell is not met but the triggering threshold related with the distance between the UE and the reference location (e.g., cell center) of the CHO candidate cell is met when the source RLF occurs, the network node can keep the triggering threshold related with the distance between the UE and the reference location (e.g., cell center) of the CHO candidate cell, but modify the triggering threshold related with the distance between the UE and the reference location (e.g., cell center) of the source cell.

In Embodiment 2, the UE indicates to the network node that it has logged and/or stored the above information, then, the network request the UE to report the logged and/or stored information, and the UE sends the logged and/or stored information to the network, e.g., the UE sends UEinformationresponse message to transfer a RLF report that including the logged and/or stored information. Based on the reported information from the UE, the network node can relax the location based triggering condition and/or the radio link quality based triggering condition, to avoid a source RLF happening before executing the CHO procedure.

### Embodiment 3 (for Solving Issue 3)

In Embodiment 3, when a CHO execution fails (e.g., a handover to a target cell selected from the CHO candidate cell(s) fails), or a source RLF occurs before the CHO execution, there may be following two options:
(1) Option 1: (as legacy mechanism in 3GPP Rel-16 CHO) a UE can perform a CHO recovery procedure if a network node configures so. For example, the UE performs cell selection, if the selected cell is a CHO candidate cell, the UE performs a handover procedure to this selected cell. If the handover procedure to this selected cell failures, the UE performs a RRC re-establishment procedure. If the selected cell is not a CHO candidate cell, the UE performs a reestablishment procedure.
(2) Option 2: The UE performs cell selection, if the selected cell is a CHO candidate cell, a UE decides whether a location based CHO execution condition configured for this candidate cell is met when this candidate cell is selected. If yes, the UE performs a handover procedure to this selected cell. If the handover procedure to this selected cell fails, the UE performs a re-establishment procedure. If the selected cell is not a CHO candidate cell, the UE performs a re-establishment procedure.

In Option 1, there is a case that the selected cell after a RLF in the source cell or a failed CHO execution is a candidate cell, a handover procedure to this selected cell is successful but its related location based CHO execution condition is not met. This means that actually this cell is the new serving cell (suitable target cell) for the UE, but since wrong configurations (e.g., inappropriate location based CHO execution condition), the UE cannot select the accurate target cell for the CHO execution procedure. In this case, it is beneficial for the network node to know the actual distance information when the handover procedure to the selected cell succeeds, and the selected cell does not satisfy its related location based CHO execution condition when the handover procedure to the selected cell succeeds. Thus, the network node can modify the location based CHO execution condition (e.g., to relax the distance based triggering threshold), to ensure that this cell can be selected as the target cell for the CHO procedure in the later CHO procedure.

In Option 1 or Option 2, there is another case that the selected cell after a RLF in the source cell or a failed CHO execution is a candidate cell, but a handover procedure to this cell also fails even its related location based CHO execution condition is met. Here “a handover procedure to this cell also fails” means that the UE fails to handover to the selected cell, or a RLF occurs shortly in the selected cell after a successful handover from the source cell to the selected cell. This means that actually this cell is not the available CHO candidate cell or target cell for the UE. In this case, it is beneficial for the network node to know the actual distance information when the handover procedure to the selected cell fails, and the selected cell fulfills its related location based CHO execution condition. Thus, the network node can exclude this cell to be a CHO candidate cell in the later CHO procedure.

In general, in Embodiment 3, if Option 1 or Option 2 is applied after the CHO execution fails or a source RLF, the UE can at least log and/or report:
(1) Distance related information when a handover procedure to the selected cell fails or succeeds. For instance, the distance related information can be: 1) a distance between a UE and reference location (e.g., cell center) of a source cell or the serving cell; 2) a distance between the UE and reference location (e.g., cell center) of the selected cell; 3) a distance between the UE and reference location (e.g., cell center) of other CHO candidate cell; 4) a distance difference between “the UE and reference location (e.g., cell center) of the source/serving cell” and “the UE and the reference location (e.g., cell center) of the selected cell”, and/or 5) a distance difference between “the UE and reference location (e.g., cell center) of the source/serving cell” and “the UE and the reference location (e.g., cell center) of other CHO candidate cell”. The distance can be calculated based on the satellite ephemeris and the UE's location.
   a) In some sub-embodiments, besides when a handover procedure to the selected cell fails or succeeds, the distance related information can also be calculated when this CHO candidate cell is selected after the source RLF or failed CHO execution.
   b) In some sub-embodiments, besides when a handover procedure to the selected cell fails or succeeds, the distance related information can also be calculated when a RRC reestablishment procedure is performed after a failed handover procedure to the selected cell, or when the RRC reestablishment procedure is performed after source the RLF or the failed CHO execution.
(2) An indication which indicates whether the selected cell fulfils its distance based CHO execution condition when the cell is selected, and/or an indication which indicates whether the selected cell fulfils its distance based CHO execution condition when the handover procedure to the selected cell fails, and/or an indication which indicates whether the selected cell fulfils its distance based CHO execution condition when the handover procedure to the selected cell succeeds. The indication(s) can be used by the network node to decide how to modify the location based CHO execution condition together with the distance related information mentioned in above (1).
(3) An indication which indicates whether “the distance between the UE and the source cell's reference location (e.g., a cell center)” satisfies its related triggering condition (e.g., the triggering threshold related with distance between UE and the cell center of the source cell) when the handover procedure to the selected cell fails or succeeds; and/or an indication which indicates whether “the distance between the UE and the selected cell's reference location (e.g., a cell center)” satisfies its related triggering condition (e.g., the triggering threshold related with distance between UE and the cell center of the selected cell) when the handover procedure to the selected cell fails or succeeds.
   a) The indication(s) can be used by the network node to decide whether the location based CHO execution condition is proper. For example, the indication(s) can be used by the network node to decide whether “the triggering threshold related with the distance between the UE and the cell center of the source cell” and/or “the triggering threshold related with the distance between the UE and the cell center of the selected cell” is proper. For instance, if “the triggering threshold related with the distance between the UE and the cell center of the source cell” is not met but “the triggering threshold related with the distance between the UE and the cell center of the selected cell” is met when the handover procedure to the selected cell succeeds, the network node can keep “the triggering threshold related with the distance between the UE and the cell center of the selected cell”, but modify “the triggering threshold related with the distance between the UE and the cell center of the source cell”, in order to ensure this cell can be selected as the target cell thus to enable a successful CHO execution.

In Embodiment 3, the UE indicates to the network node that it has logged and/or stored the above information, then, the network request the UE to report the logged and/or stored information, and the UE sends the logged and/or stored information to the network, e.g., the UE sends UEinformationresponse message to transfer a RLF report that including the logged and/or stored information. Based on the reported information from the UE, the network node can accordingly modify CHO configurations to enable successful CHO execution as much as possible. For instance, the network node can modify the location based CHO execution condition (e.g., to relax the distance based triggering threshold), or exclude the unsuitable cell from the CHO candidate cell list to avoid failed CHO execution.

### Embodiment 4 (for Solving Issue 4)

In Embodiment 4, for a traditional handover procedure in NTN, a source node may decide whether to trigger a handover procedure and/or which is the target cell based on radio link quality, traffic load, a UE's location (e.g., the distance between the UE and the reference location (e.g., cell center) of the source cell or the serving cell, the distance between the UE and the reference location (e.g., cell center) of the neighbor cell, and etc.), the network serving time (e.g., the serving time duration of the source cell or the serving cell, the serving time duration of the neighbor cell, and etc.) and etc. When a target cell is decided, the source node can send a handover command (e.g., a RRCReconfiguration message including reconfigurationWithSync IE) to the UE, and the UE can try to handover to the target cell that is indicated in the handover command.

In 3GPP Rel-16 MRO mechanism for a traditional handover procedure, a network node may only modify RRM measurement based handover triggering threshold based on a RLF report from the UE. For instance, the network node would increase the triggering RSRP/RSRQ/SINR threshold of Event A3 or A5 for RRM measurements, if the network node understands that the traditional handover procedure is triggered too early. Or, the network node would decrease the triggering RSRP/RSRQ/SINR threshold of Event A3 or A5 for the RRM measurement report, if the network node understands that the traditional handover procedure is triggered too late.

However, in a traditional handover procedure for NTN, to improve handover performance, one important thing is to set a proper distance based traditional handover triggering threshold when the network node knows whether to trigger a traditional handover procedure and what is the available target cell based on the satellite ephemeris and the UE's location. Thus, it is beneficial to let the network node know the actual location information when the too late handover procedure or the too early handover procedure or the handover procedure to a wrong cell happens.

In Embodiment 4, there is a case that a traditional handover procedure to a target cell fails, e.g., the UE fails to handover to the target cell (that is included in the traditional handover command) or a RLF occurs shortly in the target cell (that is included in the traditional handover command) after a successful handover from the source cell to the target cell. To enable a network node to decide whether mobility parameters are configured properly, some information needs to be logged and reported by the UE. The UE can log and/or report the distance related information when the handover procedure to the target cell fails, for example, upon timer T304 expires. For instance, the information can be a distance between the UE and the reference location (e.g., cell center) of the serving cell, a distance between the UE and the reference location (e.g., cell center) of the target cell, a distance between the UE and the reference location (e.g., cell center) of a neighbor cell, a distance difference between “the UE and the reference location (e.g., cell center) of serving cell” and “the UE and the reference location (e.g., cell center) of target cell”, a distance difference between “the UE and the reference location (e.g., cell center) of serving cell” and “the UE and the reference location (e.g., cell center) of the neighbor cell”, and etc. The distance related information can be calculated based on the satellite ephemeris and the UE's location.

Then, the UE indicates to the network node that it has logged or stored the above information, then, the network request the UE to report the logged or stored information, and the UE sends the logged and/or stored information to the network, e.g., the UE sends UEinformationresponse message to transfer a RLF report that including the logged or stored information. Based on the reported information from the UE, the network node can modify mobility configurations (e.g., a distance based traditional handover triggering threshold), to avoid the too early handover procedure or a handover procedure to a wrong cell.

In Embodiment 4, there is another possibility that a source RLF occurs (e.g., timer T310 or T312 expires) before a handover command is received. To enable the network node to know that the handover procedure is too late to be executed, some information needs to be reported by the UE. The UE can log and/or report the distance related information when a source RLF occurs, e.g., the distance related information can be the distance between the UE and the reference location (e.g., cell center) of the source cell or the serving cell when a source RLF occurs, a distance between the UE and the reference location (e.g., cell center) of the target cell when a source RLF occurs, a distance between the UE and the reference location (e.g., cell center) of a neighbor cell when a source RLF occurs, the distance difference between “the UE and the reference location (e.g., cell center) of the serving cell” and “the UE and the reference location (e.g., cell center) of the target cell” when a source RLF occurs, the distance difference between “the UE and the reference location (e.g., cell center) of the source/serving cell” and “the UE and the reference location (e.g., cell center) of the neighbor cell” when a source RLF occurs. The distance can be calculated based on the satellite ephemeris and the UE's location.

Then, the UE indicates to the network node that it has logged or stored the above information, then the network request the UE to report the logged or stored information, the UE sends the logged or stored information to the network, e.g., the UE sends (JEinformationresponse message to transfer a RLF report that including the logged or stored information. Based on the reported information from the UE, the network node can relax the mobility configurations (e.g., to relax the distance based traditional handover triggering threshold), to avoid the too late handover procedure.

### Embodiment 5 (for Solving Issue 5)

A SHR or a HO Success Report introduced in 3GPP Rel-17 mainly focuses on TN. For a traditional handover procedure or a DAPS HO procedure or a CHO procedure in NTN, there is a case that the UE handover to the target cell successfully, but this successful handover is on the verge of a failure, e.g., the target cell is not stable or not good enough, and the traditional handover procedure or the DAPS HO procedure or the CHO procedure is close to a failure. Similar as the successful handover report in TN, it is beneficial for the UE to generate or log a SHR for a traditional handover procedure, a DAPS handover procedure, or a CHO procedure in NTN, and thus, the network node can optimize mobility configurations, to avoid a near failure successful handover procedure.

Embodiment 5 may include following two sub-embodiments, i.e., Embodiment 5-1 and Embodiment 5-2.

### Embodiment 5-1

Considering a location based CHO procedure or a location based traditional handover procedure or a location based DAPS handover procedure in NTN, triggering condition(s) for the UE to generate or log a successful handover report, e.g., SHR at least include:
(1) While a UE is performing a handover procedure to a target cell, a distance between the UE and the reference location (e.g., cell center) of a source/serving cell is shorter than threshold 1.
(2) While the UE is performing a handover procedure to the target cell, a distance between the UE and the reference location (e.g., cell center) of the target cell is greater than threshold 2.
(3) While the UE is performing a handover procedure to the target cell, a distance difference between “the UE and the reference location (e.g., cell center) of the serving cell” and “the UE and the reference location (e.g., cell center) of the target cell” is shorter than threshold 3.

The above handover procedure can be a traditional handover procedure or a DAPS HO procedure or a CHO procedure. For a CHO procedure in NTN, threshold 1, threshold 2, or threshold 3 may be of an explicit value or a percentage. The percentage is to indicate the ratio of the threshold value over the distance based triggering threshold that is configured for a CHO execution condition. For example, the percentage value can be 20%, 40%, 60% or 80%. Threshold 1, threshold 2, and threshold 3 may be configured by a source node in the CHO command, and these thresholds can be the same or different.

For a traditional handover procedure or a DAPS handover procedure in NTN, threshold 1, threshold 2, or threshold 3 may be of an explicit value. Threshold 1, threshold 2, or threshold 3 may be configured by a source node in a handover command or a DAPS handover command, and these thresholds can be the same or different.

Correspondingly, for a location based CHO procedure or a location based traditional handover procedure or a location based DAPS handover procedure in NTN, the UE may generate or log at least following information in the successful handover report (e.g., SHR) or the HO Success Report:
(1) Distance between the UE and the reference location (e.g., cell center) of the source cell or the serving cell when the handover procedure is successful.
(2) Distance between the UE and the reference location (e.g., cell center) of the target cell when the handover procedure is successful.
(3) Distance difference between “the UE and reference location (e.g., cell center) of the source cell or the serving cell” and “the UE and the reference location (e.g., cell center) of the target cell” when the handover procedure is successful.
(4) Flag or indication to indicate which triggering condition(s) for generating or logging the SHR was fulfilled. For example, a flag which indicates that a distance between the UE and the cell center of the serving cell is equal or greater than threshold 1 and the distance between the UE and the cell center of the target cell is equal or shorter than threshold 2.
(5) Distance between the UE and the reference location (e.g., cell center) of a neighbor cell when the handover procedure is successful;
(6) Distance difference between “the UE and reference location (e.g., cell center) of the source cell or the serving cell” and “the UE and the reference location (e.g., cell center) of the neighbor cell” when the handover procedure is successful;
(7) Distance between the UE and the reference location (e.g., cell center) of a non-target CHO candidate cell when the handover procedure is successful;
(8) Distance difference between “the UE and reference location (e.g., cell center) of the source cell or the serving cell” and “the UE and the reference location (e.g., cell center) of the non-target CHO candidate cell” when the handover procedure is successful.

Therefore, in Embodiment 5-1, the network node can know that a near failure successful handover procedure happened when the network node receiving the SHR, based on the flag and distance information in the SHR. For a traditional handover procedure, the network node can transmit a handover command a bit earlier or relax the distance based traditional handover triggering threshold a bit. For a CHO procedure, the network node can transmit the CHO command a bit earlier or relax the distance based triggering threshold of the CHO execution condition a bit.

### Embodiment 5-2

Considering a time based CHO procedure, a time based traditional handover procedure, or a time based DAPS handover procedure, triggering condition(s) for a UE to generate or log a successful handover report, e.g., SHR, can at least include:
(1) Time duration between “receiving CHO configurations or a traditional handover command or a DAPS HO command” and “selecting the target cell” is equal or greater than threshold 4;
(2) The time duration between “receiving CHO configurations or a traditional handover command or a DAPS HO command” and “successfully accessing to the target cell” is equal or greater than threshold 6. Then, in the SHR, the UE can generate or log at least the time duration between “receiving CHO configurations or a traditional handover command or a DAPS HO command” and “successfully accessing to the target cell”.
(3) Time duration since the time (e.g., UTC time, or absolute time point) when the UE evaluates the CHO execution condition (e.g., CondEvent A3, A4, or A5) until selecting the target cell is equal or greater than a threshold 5. This is only for a time based CHO procedure.

For a CHO procedure in NTN, threshold 4 or threshold 6 may be an explicit value, and threshold 5 may be an explicit value or a percentage. The percentage is to indicate a ratio of the threshold value over the time based triggering threshold that is configured for CHO execution condition (e.g., t2 which is configured as the timer or time duration for the time based CHO execution condition). The percentage value can be 20%, 40%, 60% or 80%. Threshold 4 or threshold 5 may be configured by the source node in the CHO command.

For a traditional handover procedure or a DAPS handover procedure in NTN, threshold 4 or threshold 6 may be of an explicit value. Threshold 4 or threshold 6 may be configured by a source node in a handover command or a DAPS handover command, and these thresholds can be the same or different.

Correspondingly, for a time based CHO procedure or a traditional handover procedure or a DAPS handover procedure in NTN, the UE may generate or log at least information in the successful handover report, e.g., SHR:
(1) Time duration between “receiving CHO configurations or a traditional handover command or a DAPS HO command” and “selecting the target cell”.
(2) Time duration since the time when the UE evaluates the CHO execution condition (e.g., CondEvent A3, A4, or A5) until selecting the target cell.
(3) Flag or indication to indicate which triggering condition(s) for generating or logging the SHR was fulfilled. For instance, a flag which indicates that the time duration since the time when the UE evaluates the CHO execution condition until selecting the target cell is equal or greater than threshold 5.
(4) Time duration between “receiving CHO configurations or a traditional handover command or a DAPS HO command” and “successfully accessing to the target cell”.

Therefore, in Embodiment 5-2, the network node can know that a near failure successful handover procedure happened when the network node receiving the SHR, based on the flag and time information in the SHR. For a traditional handover procedure, the network node can transmit a handover command a bit earlier or relax time based traditional handover triggering threshold a bit. For a CHO procedure, the network node can transmit the CHO handover command a bit earlier or relax the time based threshold (e.g., t2) a bit for the CHO execution condition.

The method(s) of the present disclosure can be implemented on a programmed processor. However, controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device that has a finite state machine capable of implementing the flowcharts shown in the figures may be used to implement the processing functions of the present disclosure.

While this disclosure has been described with specific embodiments thereof, it is evident that many alternatives, modifications, and variations may be apparent to those skilled in the art. For example, various components of the embodiments may be interchanged, added, or substituted in the other embodiments. Also, all of the elements of each figure are not necessary for operation of the disclosed embodiments. For example, those having ordinary skills in the art would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, are defined as “including.

1. A user equipment (UE), comprising:
at least one memory; and
at least one processor coupled with the at least one memory and configured to cause the UE to:
store first information including distance information associated with a distance between the UE and a reference location, wherein the first information is at least one of radio link failure (RLF) related information, handover failure related information, or handover success related information; and
transmit the first information to a network node.

2. The UE of claim 1, wherein, in response to an occurrence of at least one of an RLF of a serving cell of the UE or a handover failure, the distance information is derived based on a satellite ephemeris and a location of the UE when the at least one of the RLF or the handover failure occurs.

3. The UE of claim 1, wherein the distance information includes at least one of:
a first distance between the UE and the reference location in a source cell of the UE;
a second distance between the UE and the reference location in a target cell of the UE;
a third distance between the UE and the reference location in a neighbor cell of the UE;
a fourth distance between the UE and the reference location in a conditional handover (CHO) candidate cell of the UE;
a first distance difference between the first distance and the second distance;
a second distance difference between the first distance and the third distance; or
a third distance difference between the first distance and the fourth distance.

4. The UE of claim 1, wherein the reference location is a cell center.

5. The UE of claim 3, wherein, in response to successfully completing a handover procedure of the UE, the distance information includes at least one of:
the first distance when the handover procedure is successful;
the second distance when the handover procedure is successful;
the first distance difference when the handover procedure is successful; or
the third distance difference when the handover procedure is successful.

6. The UE of claim 1, wherein, in response to successfully completing a handover procedure of the UE, the first information is the handover success related information, and the handover success related information is transmitted in a successful handover report (SHR).

7. The UE of claim 6, wherein the handover success related information further includes at least one of:
an indication indicating which triggering condition for generating the SHR is fulfilled;
time duration between the UE receiving CHO configuration information and the UE selecting a target cell;
time duration between the UE receiving a handover command and the UE selecting the target cell; or
time duration between the UE starting to evaluate a CHO execution condition and the UE selecting the target cell.

8. The UE of claim 6, wherein the at least one processor is further configured to cause the UE to: generate the SHR in response to meeting at least one triggering condition, wherein the at least one triggering condition includes:
a first distance between the UE and the reference location in a source cell of the UE is shorter than a first threshold while the UE performing the handover procedure;
a second distance between the UE and the reference location in a target cell of the UE is greater than a second threshold while the UE performing the handover procedure;
a first distance difference between the first distance and the second distance is shorter than a third threshold while the UE performing the handover procedure;
time duration between the UE receiving CHO configuration information and the UE selecting the target cell is greater than a fourth threshold;
time duration between the UE receiving a handover command and the UE selecting the target cell is greater than a fifth threshold; or
time duration between the UE starting to evaluate a CHO execution condition and the UE selecting the target cell is greater than a sixth threshold.

9. The UE of claim 1, wherein the at least one processor is further configured to cause the UE to:
store status information of a distance based conditional handover (CHO) execution condition, in response to an occurrence of a RLF of a serving cell of the UE or a handover failure; and
transmit the status information via the wireless transceiver to a network node.

10. The UE of claim 9, wherein the status information includes one of:
a first indication to indicate whether the distance based CHO execution condition is met when the RLF occurs;
a second indication to indicate whether the distance based CHO execution condition is met when the handover failure occurs;
a third indication to indicate whether the distance between the UE and the reference location of a source cell satisfy the distance based CHO execution condition when the RLF occurs;
a fourth indication to indicate whether the distance between the UE and the reference location of a source cell satisfy the distance based CHO execution condition when the handover failure occurs;
a fifth indication to indicate whether the distance between the UE and the reference location of the target cell or a CHO candidate cell satisfy the distance based CHO execution condition when the RLF occurs; or
a sixth indication to indicate whether the distance between the UE and the reference location of the target cell or a CHO candidate cell satisfy the distance based CHO execution condition when the handover failure occurs.

11. The UE of claim 1, wherein the first information is the handover failure related information in response to an occurrence of a handover failure, and wherein the handover failure occurs during one of:
a traditional handover procedure;
a dual active protocol stack (DAPS) handover procedure;
a CHO execution procedure;
a first handover procedure to a first selected CHO candidate cell after occurring a RLF of a source cell of the UE; or
a second handover procedure to a second selected CHO candidate cell after occurring a failure in the CHO execution procedure.

12. The UE of claim 1, wherein the at least one processor is further configured to cause the UE to:
transmit, to a network node, an indicator indicating that the first information is stored in the UE; and
receive, from the network node, a request for the first information, wherein the first information is transmitted after receiving the request.

13. A network node, comprising:
at least one memory; and
at least one processor coupled with the at least one memory and configured to cause the network node to:
receive, from a user equipment (UE), an indicator indicating that first information is stored in the UE, wherein the first information is at least one of radio link failure (RLF) related information, handover failure related information, or handover success related information, and wherein the first information includes distance information associated with a distance between the UE and a reference location; and
transmit, to the UE, a request for the first information; or
receive the first information from the UE.

14. The network node of claim 13, wherein the distance information includes at least one of:
a first distance between the UE and the reference location in a source cell of the UE;
a second distance between the UE and the reference location in a target cell of the UE;
a third distance between the UE and the reference location in a neighbor cell of the UE;
a fourth distance between the UE and the reference location in a conditional handover (CHO) candidate cell of the UE;
a first distance difference between the first distance and the second distance;
a second distance difference between the first distance and the third distance; or
a third distance difference between the first distance and the fourth distance.

15. A method performed by a user equipment (UE), the method comprising:
storing first information including distance information associated with a distance between the UE and a reference location, wherein the first information is at least one of radio link failure (RLF) related information, handover failure related information, or handover success related information; and
transmitting the first information to a network node.

16. A processor for wireless communication, comprising:
at least one controller coupled with at least one memory and configured to cause the processor to:
store first information including distance information associated with a distance between the processor and a reference location, wherein the first information is at least one of radio link failure (RLF) related information, handover failure related information, or handover success related information; and
transmit the first information to a network node.

17. The processor of claim 16, wherein, in response to an occurrence of at least one of an RLF of a serving cell of the processor or a handover failure, the distance information is derived based on a satellite ephemeris and a location of the processor when the at least one of the RLF or the handover failure occurs.

18. The processor of claim 16, wherein the distance information includes at least one of:
a first distance between the processor and the reference location in a source cell of the processor;
a second distance between the processor and the reference location in a target cell of the processor;
a third distance between the processor and the reference location in a neighbor cell of the processor;
a fourth distance between the processor and the reference location in a conditional handover (CHO) candidate cell of the processor;
a first distance difference between the first distance and the second distance;
a second distance difference between the first distance and the third distance; or
a third distance difference between the first distance and the fourth distance.

19. The processor of claim 18, wherein, in response to successfully completing a handover procedure of the processor, the distance information includes at least one of:
the first distance when the handover procedure is successful;
the second distance when the handover procedure is successful;
the first distance difference when the handover procedure is successful; or
the third distance difference when the handover procedure is successful.

20. The processor of claim 16, wherein, in response to successfully completing a handover procedure of the processor, the first information is the handover success related information, and the handover success related information is transmitted in a successful handover report (SHR).
